(19) United States
(12) Patent Application Publication
(10) Pub. No.: US 2011/0132414 A1
(43) Pub. Date: Jun. 9, 2011

(54) SOOT BLOWER

(76) Inventor: Georg Bruendermann, Thuine (DE)

(21) Appl. No.: 13/057,553

(22) PCT Filed: Jul. 8, 2009
(86) PCT No.: PCT/EP2009/058654

§ 371 Date: Feb. 4, 2011

(30) Foreign Application Priority Data
Aug. 6, 2008 (DE) 10 2008 036 686.2

(51) Int. Cl. B08B 9/00

(52) U.S. Cl. 134/167 R

(57) ABSTRACT

The invention relates to a soot blower for cleaning boilers during operation, especially for cleaning heat transfer devices located in the boilers, by means of a gaseous and/or liquid cleaning medium, such as steam and/or water jets. The soot blower displays a blow pipe that can be displaced in the axial direction and displays lateral outlet nozzles at its working end. To create an uncomplicated and safe system for routing the line to the blow pipe, the feed line can consist of at least two essentially straight, rigid line pipe sections interconnected via a swivel joint. The line pipe section forming the end of the line is connected to the inlet end of the blow pipe via a swivel joint, while the line pipe section forming the start of the line is connected, via a swivel joint, to the connecting piece of the stationary line system of the cleaning medium.

The invention relates to a soot blower for cleaning boilers during operation, especially for cleaning heat transfer devices located in the boilers, by means of a gaseous and/or liquid cleaning medium, such as steam and/or water jets, comprising a blow pipe that can be displaced at least in the axial direction and displays lateral outlet nozzles at its working end, a drive system that can be positioned outside the boiler for advancing and retracting the blow pipe, and a feed line for the cleaning medium that is connected to the blow pipe.

Large boilers have to be cleaned during operation in order to avoid stoppages. In this context, cleaning is expediently performed with the help of steam or water jets. The steam or water is fed into the boiler via a blow pipe, where the medium emerges through nozzles at the head end of the blow pipe, in which context the jets are directed at the boiler parts to be cleaned.

Known systems operate with steam at temperatures in excess of 400° C. and pressures between 6 and 21 bar, for example. The blow pipe has to be displaced over long distances in this context, up to 16 m into the boiler in known systems. A suitable seal then has to be provided between the incoming steam and the blow pipe provided with the nozzles, said seal not allowing any steam to escape to the outside, despite the enormous stroke length, meaning that the entire steam really does arrive at the nozzles. In known systems, an inner tube made of high-grade steel with an extremely smooth surface is installed in the blow pipe to this end, over which a circumferential sealing system then travels. Extremely large sealing surfaces are present on the inner tube in systems of this kind. They are subject to constant wear and require frequent maintenance, in which context the seals and the inner tube have to be replaced after reaching a certain degree of wear. The known systems are therefore relatively complex and expensive, and necessitate a substantial maintenance effort. In addition, known systems of this kind involve the risk that, in the event of a fault in the blow pipe drive, the sealing system, which is designed like a steam cylinder, is suddenly forced apart, the consequence of which can be major damage to equipment, the boiler and, in the worst case, also injury to persons.

The object of the invention is to reduce the engineering complexity of such systems, to minimise the maintenance effort and, above all, to make the system safer.

According to the invention, the object is solved in that the feed line runs into the inlet end of the blow pipe facing away from the working end, in that the feed line consists of at least two essentially straight, rigid line pipe sections, in that the line pipe sections are each interconnected via a swivel joint permitting pivoting of the line pipe sections relative to each other, in that the line pipe section forming the end of the line is connected to the inlet end of the blow pipe via a swivel joint, in that the line pipe section forming the start of the line is connected via a swivel joint to the connecting piece of the stationary line system of the cleaning medium, and in that the axes of rotation of all swivel joints are arranged parallel to each other.

In the soot blower according to the invention, sealing surfaces are present only in the relatively small swivel joints, meaning that the sealing surfaces can be kept extremely small. The wear in swivel joints of this kind is relatively low, meaning that soot blowers according to the invention need less frequent maintenance. In addition, the replacement of worn swivel joints is relatively uncomplicated and entails little effort. Moreover, the price of the necessary swivel joints is far lower than that of the sealing system in known soot blowers. Finally, the sealing system displays no units acting in the manner of a steam cylinder, meaning that there is virtually no more risk of accidents.

The number of line pipe sections interconnected via the swivel joints is preferably an even-numbered multiple. This permits very simple guidance of the articulated line pipe sections.

When using four line pipe sections, the swivel joint between the second and third line pipe section is expediently guided on a common guide rail, running parallel to the blow pipe. When using six or more line pipe sections, the swivel joints between the second and third line pipe section, between the fourth and fifth line pipe section, etc. are expediently guided on a common guide rail, running parallel to the blow pipe.

Guide elements that can be traversed on, along or in the guide rail are provided to guide the respective swivel joints. In this context, only a single, common guide rail is necessary for all guide elements.

The line pipe sections are arranged in a roughly horizontal position, in which context the swivel joints display an essentially vertical axis of rotation.

The line pipe section connected to the connecting piece of the stationary line system is preferably in the highest position in terms of level, while the following line pipe sections are arranged in successively lower positions. This measure ensures that the water condensing in the line pipe sections can run out of the blow pipe as a result of the gradient when the blowing operation is terminated. This means that the pipe system no longer contains any water when the next blowing operation starts, as a result of which no condensation water can shoot out of the blower nozzles during the next blowing operation and no harmful effects need thus be expected.

The drive system for advancing and retracting the blow pipe is preferably designed as a carriage, where the carriage is driven and guided in two guide rails running on either side of the blow pipe. In this context, the carriage is expediently connected to the outer end of the blow pipe, such that the blow pipe can be moved into and out of the boiler by advancing and retracting the carriage.

One of the guide rails of the blow pipe carriage can simultaneously serve as the guide rail for the guide elements of the respective swivel joints, this permitting further reduction of the engineering complexity.

The system according to the invention, which is particularly designed for the use of superheated steam at high pressure and offers significant advantages in this respect, can naturally also be used advantageously for water as the cleaning medium.

An example of the invention is illustrated in the drawing and described in detail on the basis of the drawing. The Figures show the following:

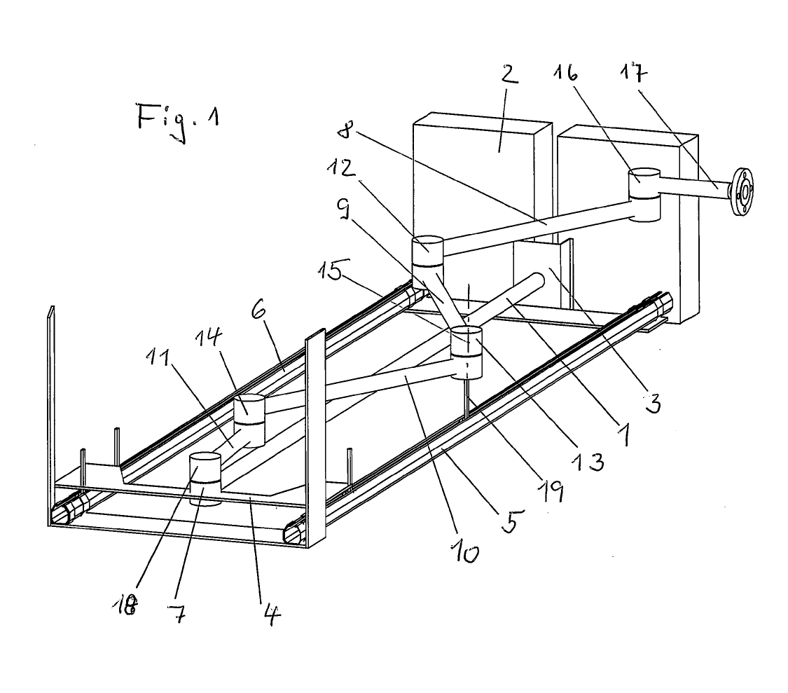

FIG. 1 A perspective view of a soot blower, where the blow pipe is shown in a position retracted from the boiler,

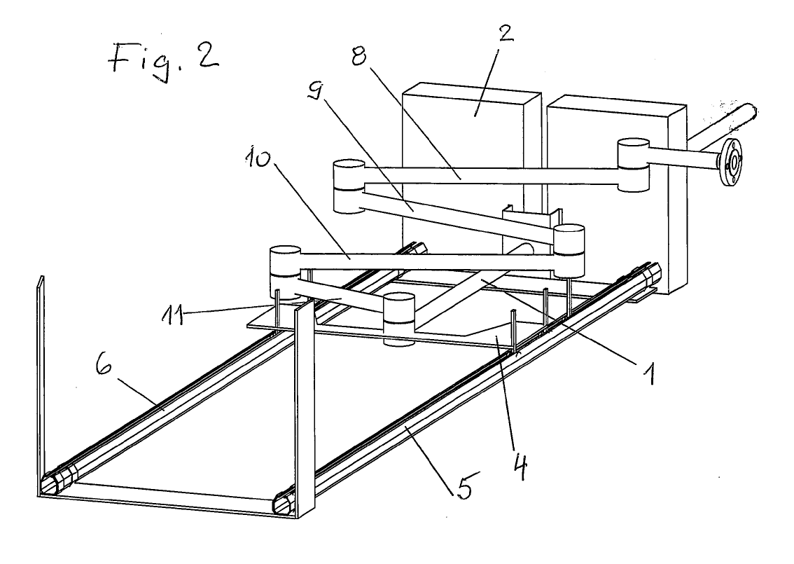

FIG. 2 The same view as in FIG. 1, but with the blow pipe partially advanced into the boiler,

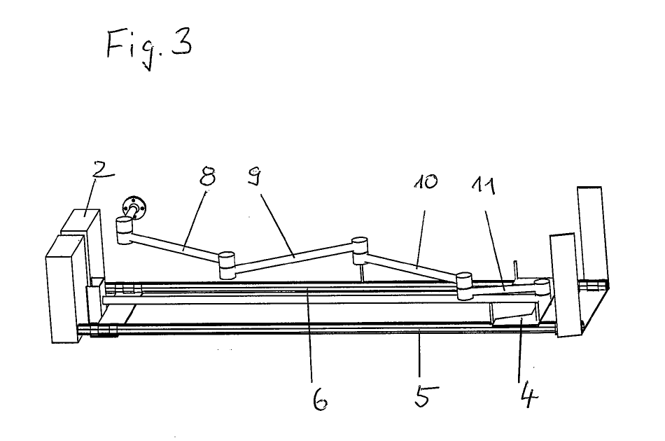

FIG. 3 A smaller side view of the blow pipe in the position shown in FIG. 1, and

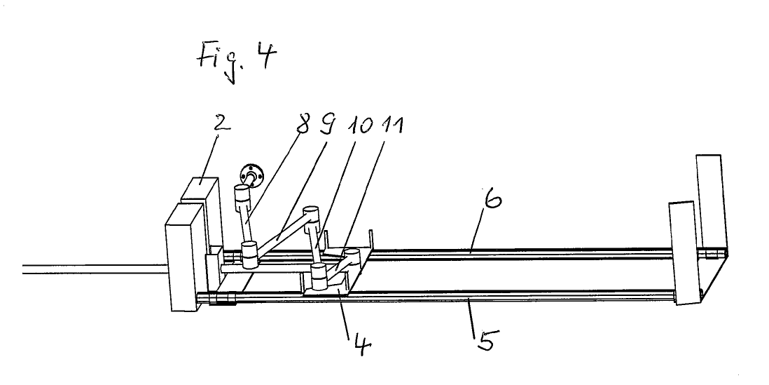

FIG. 4 The same view as in FIG. 3, but with the blow pipe in the position shown in FIG. 2, advanced into the boiler.

The soot blower shown in the drawing serves to clean boilers during operation, specifically to clean the heat transfer devices located in the boilers. The soot blower shown operates with steam having a temperature of up to 420° C. and a pressure of between 6 and 21 bar.

The soot blower essentially comprises a blow pipe 1, capable of displacement in the axial direction, that can be advanced into a schematically indicated boiler 2 and retracted again after the cleaning operation. Blow pipe 1 is guided in a supporting element 3 on the boiler side. At the opposite end, located on the side facing away from boiler 2, blow pipe 1 is fixed on a driven, traversable carriage 4. Blow pipe carriage 4 is guided on two guide rails 5, 6, running parallel to blow pipe 1, by means of which outer end 7 of blow pipe 1, facing away from boiler 2, can be moved towards boiler 2 and away from it.

The steam used for cleaning is fed to this outer end 7 of blow pipe 1 via several line pipe sections 8, 9, 10, 11. Line pipe sections 8, 9, 10, 11 consist of heat-resistant steel and are interconnected via swivel joints 12, 13, 14. Axes 15 of the swivel joints are positioned vertically, meaning that the individual line pipe sections can each be pivoted relative to each other in horizontal planes. First line pipe section 8 is connected, via swivel joint 16, to a stationary steam connecting piece 17, which is located in the vicinity of boiler 2 in the practical example illustrated in the drawing. The last line pipe section 11 in the direction of flow is connected to end 7 of blow pipe 1 via a further swivel joint 18. All swivel joints in the line are easily operated, allow the steam to pass through unhindered, and display a relatively small sealing surface. They display little wear, are maintenance-friendly and safe.

First line pipe section 8, connected to steam connecting piece 17 via swivel joint 16, is positioned at a level below that of steam connecting piece 17, and the subsequent line pipe sections 9, 10, 11 are, in turn, each positioned at a lower level than the preceding line pipe section. Blow pipe 1 is at the lowest position in the sequence of line pipe sections. When the cleaning operation has been completed and the steam supply is shut off, the condensing water can thus flow towards blow pipe 1 as a result of the successive offsets of the line pipes and drip into boiler 2 via blow pipe 1. Since blow pipe 1 is located at a point remote from the internal boiler equipment when in its inactive position, the water dripping from blow pipe 1 is completely harmless.

To permit targeted guidance of articulated line pipe sections 8, 9, 10, 11, swivel joint 13, provided between second line pipe section 9 and third line pipe section 10, displays a guide element 19, which is guided in a guide rail running parallel to blow pipe 1. In the practical example illustrated in the drawing, guidance of guide element 19 is accomplished by using one of guide rails 5, 6 that also serves to guide blow pipe carriage 4. According to FIGS. 1 and 2 of the drawing, guide element 19 of swivel joint 13 is guided in guide rail 5, located at the front in the drawing.

When blow pipe carriage 4 is driven towards boiler 2, blow pipe 1 is displaced from the position shown in FIG. 1 into the position shown in FIG. 2, gradually penetrating farther into boiler 2 in the process. In practice, the equipment illustrated in the drawing can be used to advanced blow pipe 1 up to 16 m into boiler 2. Line pipe sections 8, 9, 10, 11 are pivoted relative to each other in the process, compensating for the gradually decreasing distance between blow pipe end 7 and steam connection 17.

It is also possible to use more than four line pipe sections in order to cater to longer stroke lengths of blow pipe 1. The number of line pipe sections is expediently an even-numbered multiple in this context. If six line pipe sections are used, for example, it is also necessary for the swivel joint provided between the fourth and fifth line pipe section to be guided via a guide element, which can, similarly to guide element 19, then likewise be guided in guide rail 5.

Arbitrary, other versions of the connections between the line pipe sections are likewise possible.

### LIST OF REFERENCE NUMBERS

1 Blow pipe
2 Boiler
3 Supporting element
4 Blow pipe carriage
5 Guide rail
6 Guide rail
7 Outer inlet end of the blow pipe
8 Line pipe section
9 Line pipe section
10 Line pipe section
11 Line pipe section
12 Swivel joint
13 Swivel joint
14 Swivel joint
15 Axis
16 Swivel joint
17 Steam connecting piece
18 Swivel joint
19 Guide element

1. Soot blower for cleaning boilers during operation, especially for cleaning heat transfer devices located in the boilers, by means of a gaseous and/or liquid cleaning medium, such as steam and/or water jets, comprising a blow pipe that can be displaced at least in the axial direction and displays lateral outlet nozzles at its working end, a drive system that can be positioned outside the boiler for advancing and retracting the blow pipe, and a feed line for the cleaning medium that is connected to the blow pipe, characterised in that the feed line runs into the inlet end (7) of the blow pipe (1) facing away from the working end, in that the feed line consists of at least two essentially straight, rigid line pipe sections (8, 9, 10, 11), in that the line pipe sections (8, 9, 10, 11) are each interconnected via a swivel joint (12, 13, 14) permitting pivoting of the line pipe sections relative to each other, in that the line pipe section (11) forming the end of the line is connected to the inlet end (7) of the blow pipe (1) via a swivel joint (18), in that the line pipe section (8) forming the start of the line is connected via a swivel joint (16) to the connecting piece (17) of the stationary line system of the cleaning medium, and in that the axes of rotation (15) of all swivel joints are arranged parallel to each other.

2. Soot blower according to claim 1, characterised in that the number of line pipe sections (8, 9, 10, 11) connected via the swivel joints (12, 13, 14) is an even-numbered multiple.

3. Soot blower according to claim 1, characterised in that, when using four line pipe sections (8, 9, 10, 11), the swivel joint (13) between the second (9) and third (10) line pipe section is guided on a common guide rail (5), running parallel to the blow pipe (1).

4. Soot blower according to claim 1, characterised in that, when using six or more line pipe sections, the swivel joints between the second and third line pipe section, between the fourth and fifth line pipe section, etc. are guided on a common guide rail (5), running parallel to the blow pipe (1).

5. Soot blower according to claim 3, characterised in that guide elements (19) that can be traversed on, along or in the guide rail (5) are provided to guide the respective swivel joints (13).

6. Soot blower according to one of claim 1, characterised in that the line pipe sections (8, 9, 10, 11) are arranged in a roughly horizontal position, and in that the swivel joints (12, 13, 14, 16, 18) display an essentially vertical axis of rotation (15).

7. Soot blower according to claim 6 characterised in that the line pipe section (8) connected to the connecting piece (17) of the stationary line system is in the highest position in terms of level, and in that the following line pipe sections (9, 10, 11) are arranged in successively lower positions.

8. Soot blower according to claim 1 characterised in that the drive system for advancing and retracting the blow pipe (1) is designed as a carriage (4), and in that the blow pipe carriage (4) is driven and guided in two guide rails (5, 6) running on either side of the blow pipe (1).

9. Soot blower according to claim 8, characterised in that the blow pipe carriage (4) is connected to the outer end (7) of the blow pipe (1).

10. Soot blower according to claim 8, characterised in that one of the guide rails (5) of the blow pipe carriage (4) simultaneously serves as a guide rail for the guide elements (19) of the respective swivel joints (13).

11. Soot blower according to claim 2, characterised in that, when using four line pipe sections (8, 9, 10, 11), the swivel joint (13) between the second (9) and third (10) line pipe section is guided on a common guide rail (5), running parallel to the blow pipe (1).

12. Soot blower according to claim 2, characterised in that, when using six or more line pipe sections, the swivel joints between the second and third line pipe section, between the fourth and fifth line pipe section, etc. are guided on a common guide rail (5), running parallel to the blow pipe (1).

13. Soot blower according to claim 4, characterised in that guide elements (19) that can be traversed on, along or in the guide rail (5) are provided to guide the respective swivel joints (13).
